(19) United States
(12) Patent Application Publication
(10) Pub. No.: US 2011/0184780 A1
(43) Pub. Date: Jul. 28, 2011

(54) INTEGRATION OF eCOMMERCE FEATURES INTO SOCIAL NETWORKING PLATFORM

(75) Inventors: Chad Alderson, San Jose, CA (US); Alvin Hui, Sunnyvale, CA (US); Nisha Victor, San Jose, CA (US); Diana Williams, Burlingame, CA (US)

(73) Assignee: eBay Inc., San Jose, CA (US)

(21) Appl. No.: 13/011,324

(22) Filed: Jan. 21, 2011

Related U.S. Application Data
(60) Provisional application No. 61/297,125, filed on Jan. 21, 2010.

(51) Int. Cl. G06Q 30/00; G06Q 99/00

(52) U.S. Cl. 705/7.32; 705/27.2; 705/319; 705/14.55

(57) ABSTRACT

A method and system are provided for ecommerce marketplace users to provide contents for social networking platform integration, such as a user sharing purchases with friends so that the user may show new clothes to friends on a social networking service. Content can be transmitted to a social network server for storing at a message space of a user of the social network server and requesting the user of the social network to provide an opinion about the content. In addition, the content might include an image resembling a paper doll, the paper doll having the capability of having parts electronically superimposed with images of articles of clothing comprising all or part of an outfit. Images of such articles of clothing can be electronically superimposed on the paper doll. The paper doll with images of the articles of clothing can be transmitted to friends on a social network for an opinion or for completion of the outfit.

### RELATED APPLICATIONS

This application is related to and claims priority to provisional patent application Ser. No. 61/297,125 entitled “Integration of ecommerce Features into Social Networking Platform,” which was filed on Jan. 21, 2010, which is assigned to the assignee of this application, and which is hereby incorporated herein by reference in its entirety.

### BACKGROUND

Applications available on the Internet have progressed from facilitating a medium of information delivery to a venue for sales and, more recently, to a platform for social networking. An online marketplace such as eBay.com is an example of an online seller. Similarly, mySpace.com and Facebook.com are examples of social networking.

### TECHNICAL FIELD

The subject matter disclosed herein generally relates to the processing of data. Specifically, the present disclosure addresses systems and methods of providing content generated by a user of an ecommerce network for social network platform integration.

### BRIEF DESCRIPTION OF THE DRAWINGS

Some embodiments are illustrated by way of example and not limitation in the figures of the accompanying drawings in which:

FIG. 1 is a network diagram depicting a system, according to one example embodiment, having a client-server architecture;

FIG. 2 is a block diagram illustrating social applications, according to an embodiment;

FIG. 3 is a block diagram illustrating a database, according to an embodiment;

FIG. 3A is an illustration of a system usable with or as part of the system of FIG. 1.

FIG. 4A is a an illustration of a screen shot for getting an opinion, according to an embodiment;

FIG. 4B is an illustration of a screen shot for getting all opinion that includes the identity of the person giving the opinion.

FIG. 4C is an illustration of a screen shot depicting a method of using a social influencer.

FIG. 5 is an illustration of a paper doll-like outfit builder according to an embodiment;

FIG. 6 and FIG. 7 are an illustration of an application of the ecommerce Window shopper feature of example embodiments;

FIGS. 8A through 8C illustrate flow diagrams explaining operation of certain embodiments; and

FIG. 9 is a block diagram illustrating components of a machine, according to some example embodiments, able to read instructions from a machine-readable medium and perform any one or more of the methodologies discussed herein.

### DETAILED DESCRIPTION

In the following description, for purposes of explanation, numerous specific details are set forth in order to provide embodiments of the subject matter set forth in the present disclosure, it will be evident, however, to one skilled in the art that the present disclosure may be practiced without these specific details.

Content may be provided over a network from a first server to a second server. The first server may be, e.g., a web server, a database server, or a listing server. For example, a network-based publication system may include a first web server that provides content over a network to the second web server. Specifically, the second server may be a third-party social network server that provides a social networking service (e.g., Facebook®) to millions of users and provides social network data.

Each of the first server and second server may provide the content to one or more client machines, which client machines may be the same client machine or a different client machine.

A client machine may be a computer, a mobile device, or other machine functioning, temporarily, or permanently, as a client in relation to the content machine. For example, the client machine may, as indicated above, have a user. The user may be a human user or a machine-implemented user (e.g., software executing on the client machine). The content provided by the social network server may be presented to a client machine and thence to the user by the client machine. Other couplings between these or similar servers and one or more client machines may be used.

In some example embodiments, a system and method for sharing shopping information on a network-based social platform is illustrated. A request may be received from a first user of a network-based social platform to add an item to a list associated with a second user of the network-based social platform. The item may be listed for sale on a network-based marketplace. The list may include one or more items and facilitate watching the items in real time (e.g., a watch list) on the network-based social platform to monitor the progress of an auction or an immediate purchase of the item on the network-based marketplace. Next, in some embodiments, the system may determine whether the first user is authorized to add the item to the list based on a predetermined relationship between the first user and the second user. For example, a predetermined relationship may have been consensually established by the first and second users on the network-based social platform and may, in some embodiments, include the relationship “friend” or “favorite friend.” Other social network platforms use the concept of “following” in which one person can follow another person or topic without there necessarily being a two-way relationship. Finally, the system may communicate the request to the network-based marketplace which, in turn, adds the item to the list associated with the second user. Accordingly, in some embodiments, a first user on a network-based social platform may share shopping information concerning an item for sale on a network-based marketplace with a second user on a network-based social platform by adding the item to a list used to monitor the item on the network-based social platform. In some embodiments, the second user may block the first user from adding the item to the watch list of the second user, or may delete after it has been added or posted.

### Platform Architecture

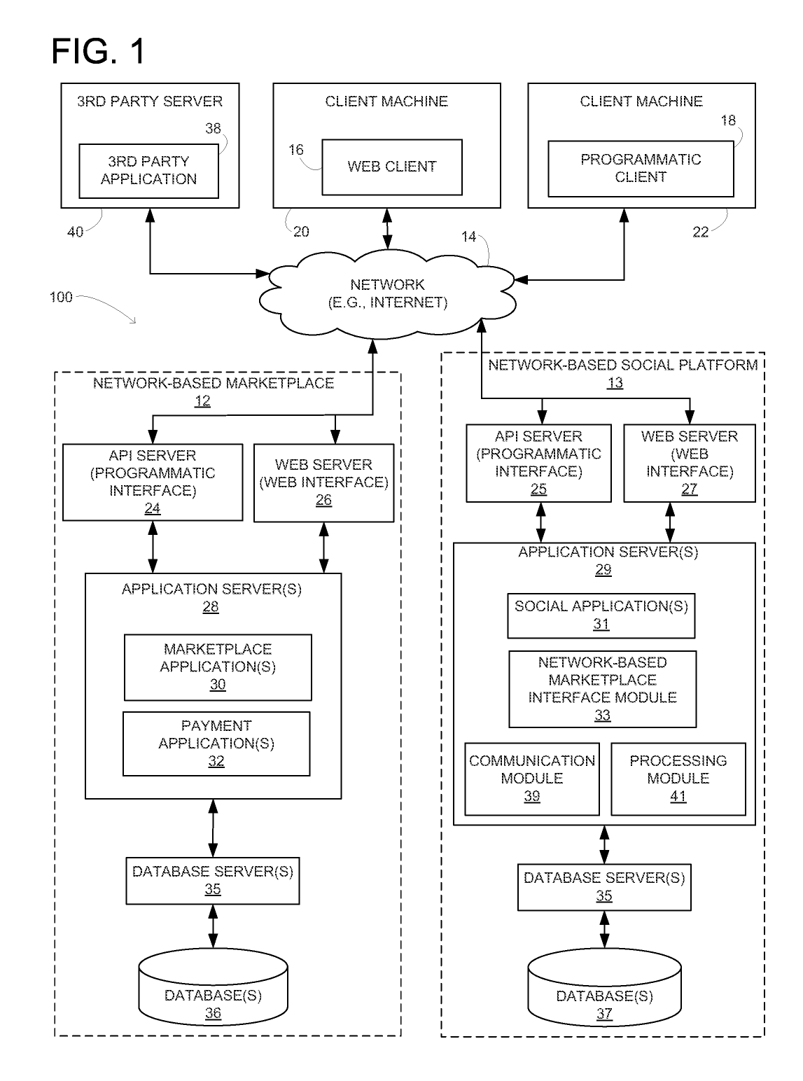

FIG. 1 is a network diagram depicting a system 100, according to one embodiment of the present disclosure, having a client-server and a peer-to peer architecture. The system 10 facilitates shopping activity, in the exemplary form of a network-based marketplace 12 and a network-based social platform 13 that communicate over a network 14. In one embodiment, the network-based marketplace 12 and the network-based social platform 13 communicate in peer-to peer architecture via programmatic interfaces. Further, the network-based marketplace 12 and the network-based social platform 13 respectively communicate in client-server architecture with clients. The network-based marketplace 12 provides server-side functionality, via the network 14 (e.g., the Internet), to the one or more client machines 20 and 22. Similarly, the network-based social platform 13 provides server-side functionality, via the network 14 (e.g., the Internet), to the one or more client machines 20 and 22. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based social platform 13, an application program interface (API) server 25 and a web server 27 are coupled to, and provide programmatic and web interfaces respectively to, one or more application servers 29. The application servers 29 may host one or more social applications 31 and a network-based marketplace interface module 33 that communicates with a communication module 39 and a processing module 41. The application servers 29 are, in turn, shown to be coupled to one or more database server(s) 35 that facilitate access to one or more database(s) 37.

The social applications 31 provide a number of social networking functions and services to users that access the network-based social platform 13. For example, the social applications 31 may enable a user to store information in a profile that may be viewed at the client machines 20, 22 and to selectively grant access to information that appears on the profile to other users who may also view the profile at their client machines 20, 22. The social applications 31 may provide criteria that may be employed by a user to grant various levels of access to various levels of users. For example, a first user may access profile information associated with a second user responsive to the first user achieving the status of “friend” in relation to a second user. A user may achieve the status of friend by accepting an invitation from another user or by sending a request to a user that subsequently grants die request.

The social applications 31 may further enable third-party service providers to add “applications” on the network-based social platform 13 that are utilized by users to interact with other users. For example, a network-based marketplace application may be added by a third-party service provider in the form of the network-based marketplace interface module 33, the communication module 39, and the processing module 41 that may provide market application services in the network-based social platform 13 environment and may communicate with the network-based marketplace 12.

In one embodiment, a request related to the marketplace application may be generally processed as follows. The request may originate at the client machines 20, 22 that communicate the request via programmatic or web interface services 25, 27 to the social applications 31 that, in turn, communicate the request to the network-based marketplace interface module 33 that, in turn, communicates the request to the communication module 39 and processing module 41 that process the request. Conversely, the communication module 39 and processing module 41 may respond to the social applications 31 via the network-based marketplace interface module 33. In some instances processing of the request may require communication with the network-based marketplace 12. In such instances the communication module 39 or the processing module 41 may communicate via the API server 25 with the network-based marketplace 12.

The network-based social platform 13 may be embodied as FACEBOOK® services, a social utility that connects people with friends and others who work, study and live around them provided by Facebook of Palo Alto, Calif.

The web client 16, it will be appreciated, in one embodiment accesses the various social applications 31 via the web interface supported by the web server 27. Similarly, the programmatic client 18 in one embodiment accesses the various services and functions provided by the social applications 31 via the programmatic interface provided by the API server 25.

Turning to the network-based marketplace 12, an application program interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more database server(s) 35 that facilitate access to one or more databases 36.

The marketplace applications 30 provide a number of marketplace functions and services to users that access the network-based marketplace 12. The payment applications 32 likewise provide a number of payment services and functions to users. The payment applications 32 may allow users to quantify for, and accumulate, value e.g., in a commercial currency, such as the U.S. dollar, or a proprietary currency, such as “points”) in accounts, and then later to redeem the accumulated value for products (e.g., goods or services) that are made available via the marketplace applications 30. While the marketplace and payment applications 30 and 32, respectively, are shown in FIG. 1 to both form part of the network-based marketplace 12, it will be appreciated that, in alternative embodiments of the present disclosure, the payment applications 32 may form part of a payment service that is separate and distinct from the network-based marketplace 12. The network-based marketplace 12 may be embodied as eBay, the world's online marketplace, provided by eBay of San Jose, Calif.

Further, while the system 100 shown in FIG. 1 employs a client-server architecture and a peer-to-peer architecture, the present disclosure is of course not limited to such an architecture, and could equally well find application in any combination of client-server, distributed, or peer-to-peer, architecture systems. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings of items on the network-based marketplace 12 in an off-line manner, and to perform batch-mode communications between the programmatic client 18 and the network-based marketplace 12.

It will be appreciated that the marketplace applications 30, payment applications 32, social applications 31, the network-based marketplace interface module 33, the communication module 39 and the processing module 41 may execute on a single platform. Accordingly, in one embodiment, the aforementioned applications/modules may execute on the network-based marketplace 12 and in another embodiment the aforementioned applications/module may execute on the network-based social platform 13.

FIG. 1 also illustrates a third-party application 38, executing on a third-party server machine 40, as having programmatic access to the network-based marketplace 12 via the programmatic interface provided by the API server 24. For example, the third-party application 38 may, utilizing information retrieved from the network-based marketplace 12, support one or more features or functions on a website hosted by the third party. The third-party website may, for example, provide one or more promotional, marketplace or payment functions that are supported by the relevant applications of the network-based marketplace 12.

### Social Platform Applications

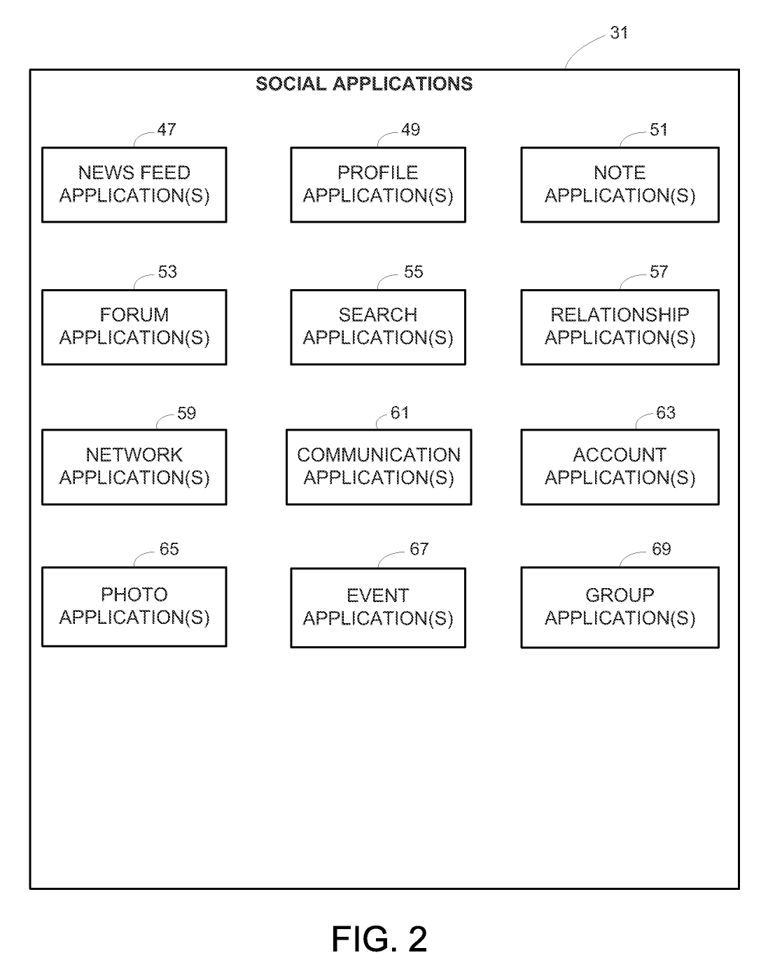

FIG. 2 is a block diagram illustrating applications that execute on the network-based social platform, according to an embodiment. The network-based social platform applications include news feed applications 47, profile applications 49, note applications 51, forum applications 53, search applications 55, relationship applications 57, network applications 59, communication applications 61, account applications 63, photo applications 65, event applications 67, and group applications 69.

The news feed applications 47 publish events associated with the user and friends of the user on the network-based social platform 13. The news feed applications 47 may publish the events on the user profile of a user. For example, the news feed applications 47 may publish the uploading of a photo album by one user on the user profile of the user and the user profiles of friends of the user.

The profile applications 49 may maintain user profiles for each of the users on the network-based social platform 13. Further, the profile applications 49 may enable a user to restrict access to selected parts of their (profile to prevent viewing by other users. The note applications 51 may be used to author notes that may be published on various user interfaces.

The forum applications 53 may maintain a forum for users to post comments and display the forum via the profile associated with a user. The user may add comments to the forum, remove comments from the forum and restrict visibility to other users. In addition, other users may post comments to the forum.

The search applications 55 may enable a user to perform a keyword search for users, groups, and events. In addition, the search applications 55 may enable a user to search for content (e.g. favorite movies) on profiles accessible to the user.

The relationship applications 57 may maintain relationship information for the users. The network applications 59 may facilitate the addition of social networks by a user, the social networks based on a school, workplace, or region or any social construct for which the user may prove an affiliation. The communication applications 61 may process incoming and outgoing messages, maintain an inbox for each user, facilitate sharing of content, facilitate interaction among friends (e.g., poking), process requests, process events, process group invitations and process communicating notifications.

The account applications 63 may provide services to facilitate registering, updating, and deleting user accounts. The photo applications 65 may provide services to upload photographs, arrange photographs, set privacy options for albums and tag photographs with text strings. The event applications 67 may provide services to create events, review upcoming events, and review past events. The group applications 69 may be used to maintain group information, display group information, and navigate to groups.

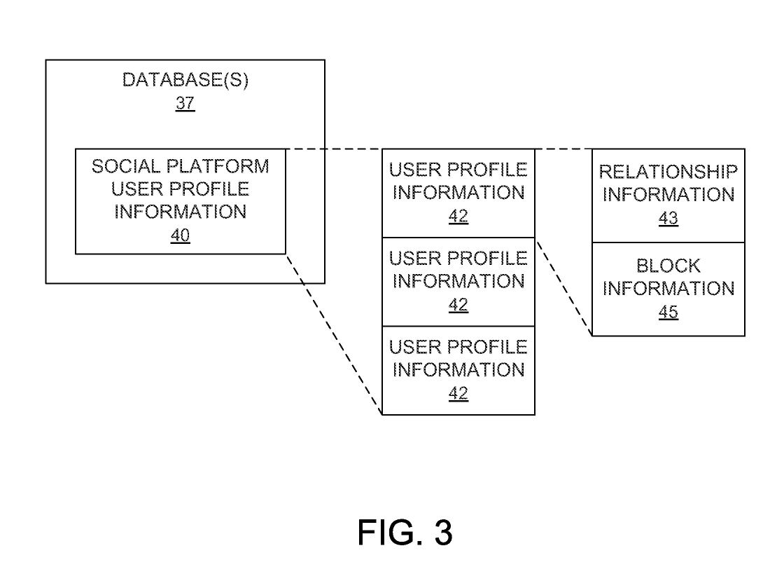

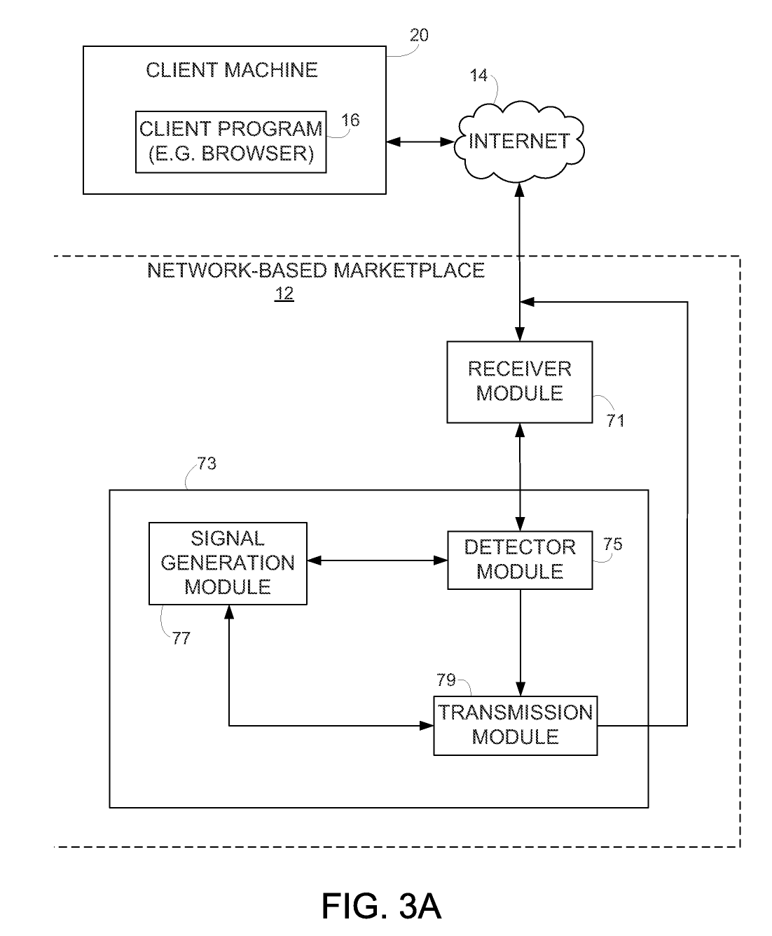

FIG. 3 is a block diagram illustrating a database 37, according to an embodiment, at the network-based social platform 13 of FIG. 1. The database 37 is shown to include social platform user profile information 40 that stores user profile information 42 for each user on the network-based social platform 13. The user profile information 42 may include information related to the user and specifically may include relationship information 43 and block information 45. The relationship information 43 may store a predetermined relationship between the user associated with the user profile information 42 and other users on the network-based social platform 13. For example, a first user may be designated a “friend,” or “favorite friend,” etc. with a second user, the first user associated with the user profile information 42 and the respective designations associated with increasing levels of disclosure between the first user and second user. The block information 45 may store a configured preference of the user to block the addition of an item by other users to the watch list associated with the user.

Turning to FIG. 3A, there is seen a system that forms part of the transaction network-based marketplace 12 of FIG. 1. The network-based marketplace 12 is shown in part in the drawing to make it clear that the system forms only a part of the network-based marketplace 12. The system includes a receiver module 71 for receiving signals from client machine 20, the signals identifying content to be transmitted to a social network server for storing at a message space of a user of the social network server. As used herein, “signals” could mean analog signals or digital signals such as web-based messages, including packet-based messages, or even a request message via an API call. Also included is analysis module 73. Analysis module 73 includes detector module 75 responsive to the receiver module 71 for detecting the content, the identity of the social network, and the identity of the user of the social network. The analysis module 73 also includes a signal generation module 77 coupled to the detector module 75 responsive to the detection of signals such as, for example, signals identifying the content, the identity of the social network, and the identity of the user of the social network, for whom the content is intended, and other types of signals.

The signal generation module 77 can provide a rendering signal for rendering at least the content of the received signal. This rendering signal is transmitted by transmission module 79 via network 14 to a social network, not shown. Alternatively, instead of transmitting signals via the network to a social network server, the transmission module 79 may transmit the signals, either via the network 14 or internally to the network-based marketplace 12, to a social platform integrated within a network-based marketplace 12. Further, the signals from signal generation module 77 may include signals such as signals requesting a user of the social network for an opinion about the content, or for outfit suggestions about the content, among other things, as more fully discussed below,

### User Stories: Social Networking Platform Integration

Disclosed herein are ecommerce marketplace user stories for social networking platform integration, according to some example embodiments,

### Share My Transaction

As an ecommerce marketplace user (e.g., an eBay or Amazon.com user), a user can share purchases with friends so that the user may show new clothes to friends on a social networking platform (e.g., Facebook.com or a platform integration within an ecommerce marketplace). An ecommerce marketplace can be referred to as an ecommerce marketplace. These clothes, and other items similarly shared with friends as discussed herein, may be termed “commercial items.” For example, at the end of ecommerce marketplace checkout flow, the user may be provided with the ability to post her transaction involving a commercial item to a social network wall. This wall concept is sometimes referred to herein as “storage space,” and could include renderable or viewable storage space. The user may tag a post with friends so that it shows up in their social graph(s). The post could include a picture and certain item information. Further, the friend could be provided with a user selectable “See similar” function to see similar pictures and item information. For example, there is a “See Similar’ function on eBay's fashion page which can be located adjacent to the item listing, or the item's photo as a link. It could also be added as a contextual pop-up. The shared post could include selection like “commentable” or “likeable.” These cases describe interactions that would feed into the social network, for example, Facebook. “Commentable” means that the marketplace user can share a particular product or item with his or her social graph via the Facebook Wall and include a comment along with it. “Likeable” means a Facebook user can provide a Facebook thumbs up if he or she likes the product or item. A social network user may also be able to provide a thumbs down if he or she doesn't like the product or item.

### Get an Opinion

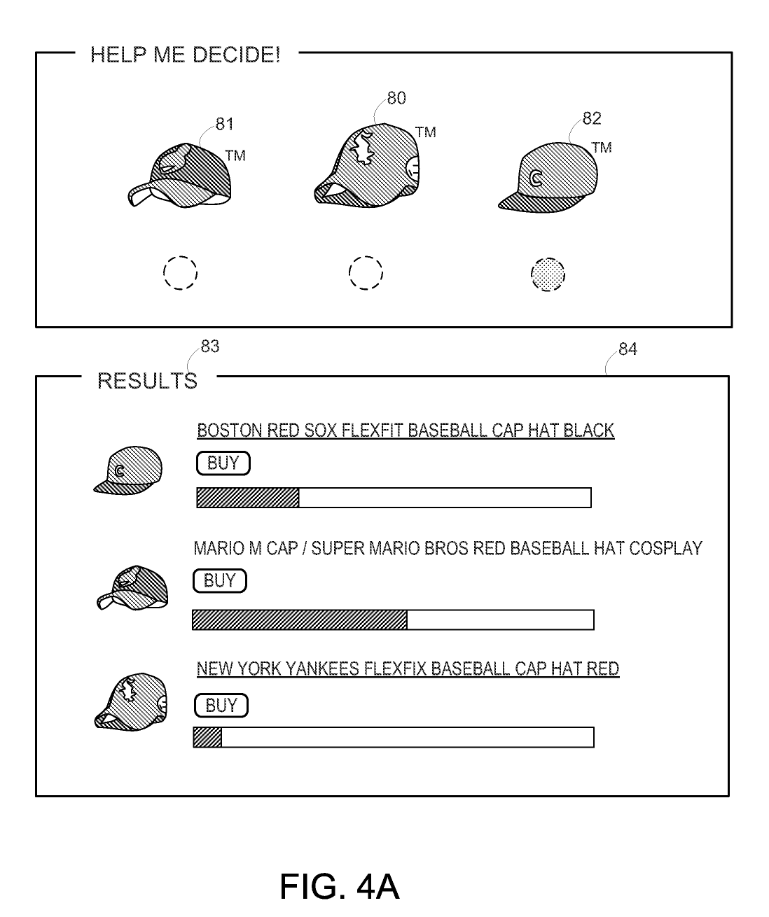

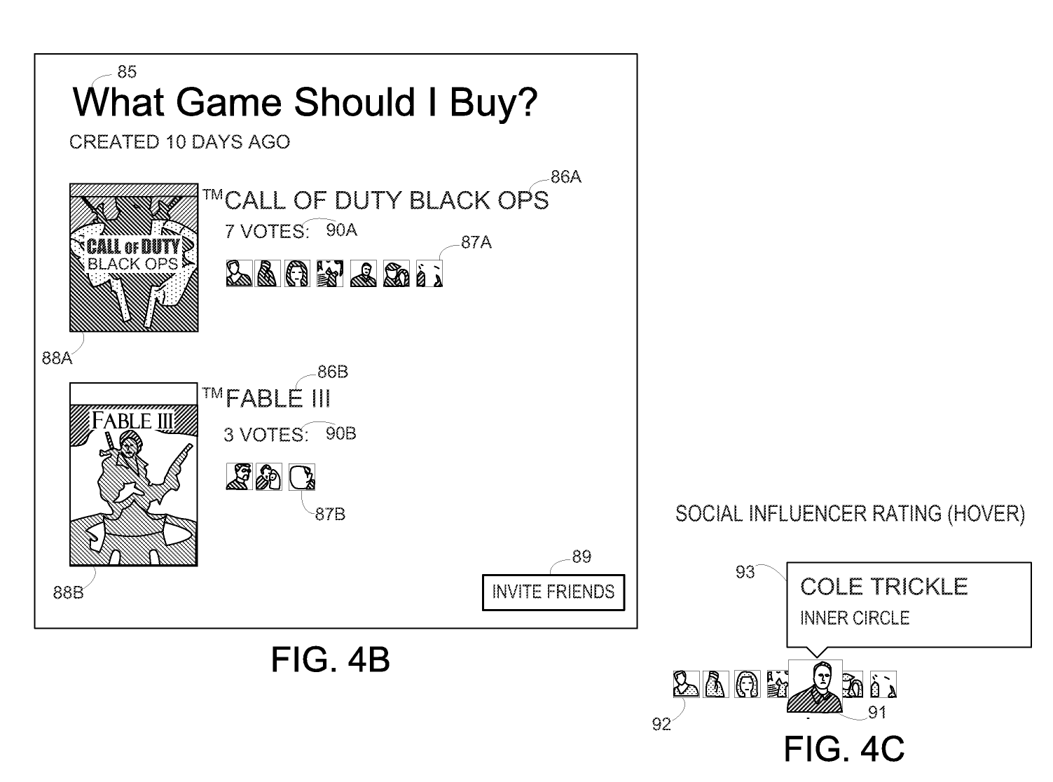

An ecommerce marketplace user may like to get the opinions of friends before buying an item on an ecommerce marketplace. To do this, a user can push an item to a social networking platform in the form of a poll. For example, as seen in FIG. 4A, a user can select a single cap 80, or can select a number of caps 80, 81, 82, using, for example, the “See Similar” function of eBay's fashion market, and push the cap(s) to a social networking platform using social applications 31 discussed above with respect to FIG. 2. This can be in the form of a poll such as the “Help Me Decide” function of FIG. 4A. If the user pushes only one item, the poll is simply a yes/no vote. If the user pushes two items to the same poll, it becomes a “vs.” poll. If the user pushes more than two items to the same poll it becomes a multiple choice poll. The user may tag the poll with friends so that it shows up in their social graph(s). In this context, friends could pick their favorite option or leave a comment. Once a social network user votes, the results 83 are tallied and shown to the person who just voted. The owner of the poll may see the results of the poll at any time by viewing it within the context of the social networking platform. The results could be illustrated graphical form illustrating the percentage of votes for each item, such as in the “Results” area 84 of FIG. 4A. Each item in the poll may have a link to eBay's View Items Page, which is May's main page where the user bids on an item at an auction, or buys it now (BIN) so that anyone may buy the item.

FIG. 4B illustrates another embodiment of the user asking for an opinion. In this case, the user of an ecommerce marketplace such as eBay selects two games he might buy. He can do this by selecting a first game and using the “See Similar” function to see similar games from which he may select the second game. The user sends the identity of the two games with a request for an opinion poll. This could take place by the user, as poll owner, engaging eBay's network-based publication system to provide content from an eBay server over network 14 of FIG. 1 to a third-party social network server that provides a social networking service (e.g., Facebook®). The poll owner at a client machine 20 could see the names 86A and 86B of the selected games, which could also be identified by thumbnails 88A and 88B. Radio button 89A, when selected, could invite friends, over the network 14, using network-based social platform 13, to take the poll and select which of the games the friends think the poll owner should buy. When the friends vote, their votes are tallied and rendered, as at 90A and 90B, and the identity of the voters who voted for the particular game can be rendered, as at 87A and 87B.

The opinions of certain voters may count more to the poll owner than the opinions of other voters. In other words, there is a certain social influence that can occur depending on the voter. The voter can have a certain social influencer rating. This is seen in FIG. 4C. When the poll owner hovers the cursor over the thumbnails of the voters, they can be made to stand out or be highlighted such as, for one example, by being magnified, perhaps growing two-times in size to easily identify the friend at 91 who cast a vote for a particular game. The social influence thereby occurs, influencing the poll owner to buy a certain game based, perhaps, on the identity of the friends who voted for the particular game. The thumbnail photographs of the voters, in one embodiment, can be built from 50×50 px squares, of the friend's profile pictures collected from Facebook by network-based social platform 13 of FIG. 1. For example, if a poll owner positions the cursor over any thumbnail, certain fly-out navigation can appear over each picture as at 91 in FIG. 4C, with a mini-profile card including an image of the friend offering the opinion as at 93, (as mentioned, the social influence rationale being that certain friends' opinions matter more than the opinions of others). The other photographs would remain in the background as at 92. The poll owner could also consider providing feedback on which of the items the user purchased. In the case of clothing this feedback can be implemented by adding closed loop feedback from a tool such as, for example, a purchase from the outfit builder tool discussed below.

### Social Networking Platform Alert Daemon

An ecommerce marketplace user may like to be notified of great deals like Flash Sales and Outlet sales on an ecommerce marketplace within her social networking platform context. The user could be given the ability to subscribe to Flash Sale Alerts from within the ecommerce marketplace. The ability to follow feed items (flash, seller, etc.), which are of special interest to the user, can then be streamed into her Facebook wall or other social network storage space of the user (including renderable storage space), and she may also have the ability to share alerts with Facebook or other social network friends. For example, a flash seller could be an entity the network-based marketplace has entered into a development agreement with, for example an HDTV manufacturer that has a surplus of fifty-inch television sets that need to move quickly; this can result in a discounted Flash Sale. “Following” a flash sale basically means that a consumer has expressed interest in being alerted if that manufacturer has any discounted sales on the marketplace, such as eBay. The user can do this by opting into a signup form on the manufacturer's page of the marketplace, filling out a questionnaire for that purpose. The mechanism to share with friends alerts for sales could simply be a link under the sale in question, for example a manufacturer might have a fitly percent (50%) off sale, and the link could be directly under, or near, the notice of the offer. Selecting the link could enable the ecommerce marketplace to collect the target user's email address or Facebook handle and then push that sale information to either the target user's email account or the target user's Facebook

### Outfit Builder on Social Networking Platform

As an ecommerce marketplace user who is also on a social networking platform, one may like a way to quickly build images of entire outfits and share/recommend them with friends so that she may show people how stylish she is.

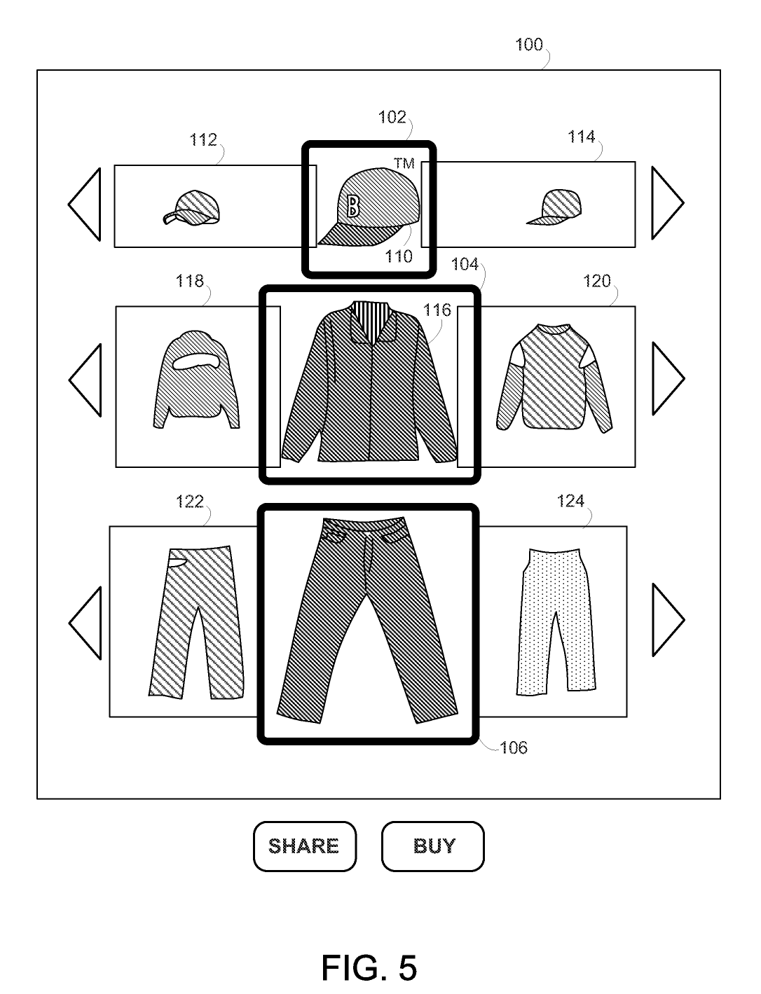

As seen in FIG. 5, a paper doll-like UI 100, sometimes herein called “Outfit Builder tool” or “Paper-Doll tool,” allows the user to mix and match images of pieces of an outfit quickly and easily, for example, by drag and drop functions. For example, a paper-doll like representation is presented in boxes 102, 104, 106. The user could have the ability to upload a “paper doll” of themselves or of a friend on Facebook and then dress that doll via the tool. In one embodiment the eBay user can take a picture of herself and upload it to the eBay site where the paper doll tool can be hosted. The head of that person then becomes the head of the paper doll. Alternatively, the user can upload a picture of a friend and have the friend's picture appear as the face of the paper doll. The paper doll can be rendered for the user at the client machine, and the user can dress the paper doll as discussed below.

While the paper doll-like figure is shown as boxes 102, 104, 106 for caps, tops/jackets and pants, it could just as easily be in another form, such as a stick drawing of a person or a full drawing of a person. While only clothes are shown as the outfit, the outfit could include shoes and clothing accessories worn for a fashionable effect. The user would have the ability to “pivot” on, or select, an item listing in order to view one or more similar listings within a set of item listings on an ecommerce site using, for example, a similar items algorithm. As one example, the user could select items similar to the selected item by using a selectable “Find Similar Items” function of the type seen on fashion pages on the eBay site. Similar item listings to the item or item listing “pivoted” on would then be rendered to the user. As another example, the user could use eBay's selectable silhouette navigation to select similar articles of clothing, shoes, and accessories of a selected type. The user could then leverage merch personalization (e.g., cloth sizes, sizes, gender, top categories) and tap into a user's Facebook profile to determine favorite brands, etc. Stated another way, the user can access (Or tap into) a friend's Facebook profile, obtain the Friend's favorite brands, sizes, colors, and the like, from the profile, and then dress the paper doll with the friend's favorite brands, sizes, colors, and the like. The eBay user could then send the outfitted paper doll to the Facebook friend, for example, by sending it to the friend's storage space (or wall) on Facebook. Using this, one could create and push sets out into user's social graph or browse the user's sets on a social networking platform. The user could push “set” recommendations to friends with the outfit builder UI. The Facebook friend could choose to buy all or part of the outfit on eBay. The user who put the outfit together can then be rewarded with something like eBay Bucks, which is an affiliate of eBay. Purchases could be made on the eBay site.

One could have an optional hook, or connection, to an affiliate program, on an ecommerce site, such as the eBay Affiliate program. If the builder chooses, he or she may join the affiliate program and the builder may get a percent of the sale (real money). The builder may also earn virtual points on the social networking platform, (not tied to a sale, but tied to views or some other metric. Dollars or virtual points could be credited after a person to whom the user has made an outfit recommendation using the Paper Doll tool has made a purchase. These virtual points may be redeemed to acquire unique contest-related items offered by the ecommerce marketplace, be ranked against your peers, or be ranked against a social networking platform community. The higher one's rank, the higher one's social status. For example, one could be elevated to the rank of a Chanel® brand expert. One could be given a visual indicator of that rank, similar to, say, a badge. Other marketplace users would then see that that user is a recognized expert in Chanel® items and may choose to engage the user to help them with their purchase decisions or have discussions, provided the user allows it. With the above as general background, examples of using the Outfit Builder tool are discussed below.

Build Outfits and Share them with/Recommend them to Friends

If an ecommerce marketplace user is also on a social networking platform, she might like a way to quickly build entire outfits and share them with or recommend them to friends so that she may show people how stylish she is. The paper doll UI described below allows a user to mix and match pieces quickly and easily for social network use, or for general use. Users can upload to a site like eBay a picture of themselves and pictures of a couple of items from their personal closet. The personal closet could be the user's physical closet or their virtual closet on an ecommerce site such as eBay. For example, the user may navigate to an “eBay Closet” associated with the user, where images of saved items are stored. A user scenario could be that Nicola, an eBay Fashion enthusiast, decides to use the eBay Fashion Paper doll toot to help her with her Fashion crisis. She has this grey pant that she is usually not sure what to wear with. She takes a picture of the grey pant, in this case from her physical closet. She then uploads the photo and the grey pant is superimposed on the tool as the paper dolls legs.

Nicola then contacts via the Poll Your Friends/eBay community option. Polling allows Nicola to reach out to her friends on Facebook or to reach out to other eBay Fashion Community members and ask their opinion to help influence her purchase decision. Nicola can poll other eBay users to help dress the paper doll with other items from eBay that will go with this grey pant. She can also set a budget, for example, not to exceed a total of $200.

Those users who wish to participate could then pull Nicola's paper doll dressed in the grey pants over to their workspace and fill in the missing parts like shirts, shoes, accessories, hand bags, coats, scarves etc. They could do so by browsing the Fashion site on an ecommerce marketplace such as eBay, navigating to an item, and then clicking on Add to Paper Doll list. The item would then get ported over to the Paper Doll list and the user can then go to the tool and drag and drop the item on the paper doll's legs if it is a pant or on the paper doll's top if it is a shirt, etc. A further ability would allow the users to pivot on any piece within the set using a “Similar Items” algorithm as discussed above.

As another example, Sophie decides to participate in dressing up the paper doll and starts pulling together shirts from eBay. She finds this white shirt but she doesn't like the black buttons on it. She decides to look for other similar items using eBay's “Similar Stems” algorithm, and then reviews the resulting similar items to determine which item she prefers.

As an example of leveraging merchandise personalization (e.g., clothing sizes, gender, top categories and of tapping into a user's Facebook profile to determine favorite brands, etc., as discussed briefly above, consider the following scenario. One of the other users on eBay, Isabelle, happens to be Nicola's Facebook friend. Isabelle also decides to participate in the paper doll poll. Being Nicola's friend on Facebook, Isabelle can also see Nicola's favorite brands, so she searches on eBay for items from Nicola's favorite brands that will go with the grey pants. Isabelle goes to Nicola's eBay Fashion wall and submits the items that will go with her grey pants. She can then put together the various pieces using the Outfit builder tool and compile a couple of full outfits by dragging a shirt, a scarf, a bag and shoes that go with the grey pants. She can then save it and submit it to Nicola's friend's suggestion walls where other users and Nicola can rate it.

Creating and Pushing Sets Out into a User's Social Graph

Users have now begun responding to Nicola's paper doll poll by rating the outfits that other users have compiled. Nicola browses through some of the sets that other users have put together, pulls three of her favorites and creates a another poll asking her friends to weigh in on which look would suit her best. If a user puts together a set for Nicola and Nicola decides to buy an item from this set, then the user who compiled that set together could get a percentage of the revenue of the sale, if the user belongs to an affiliate program on the ecommerce site where the purchase is made. This is an example of the eBay Affiliate program discussed above.

### Commerce System Window Shopper

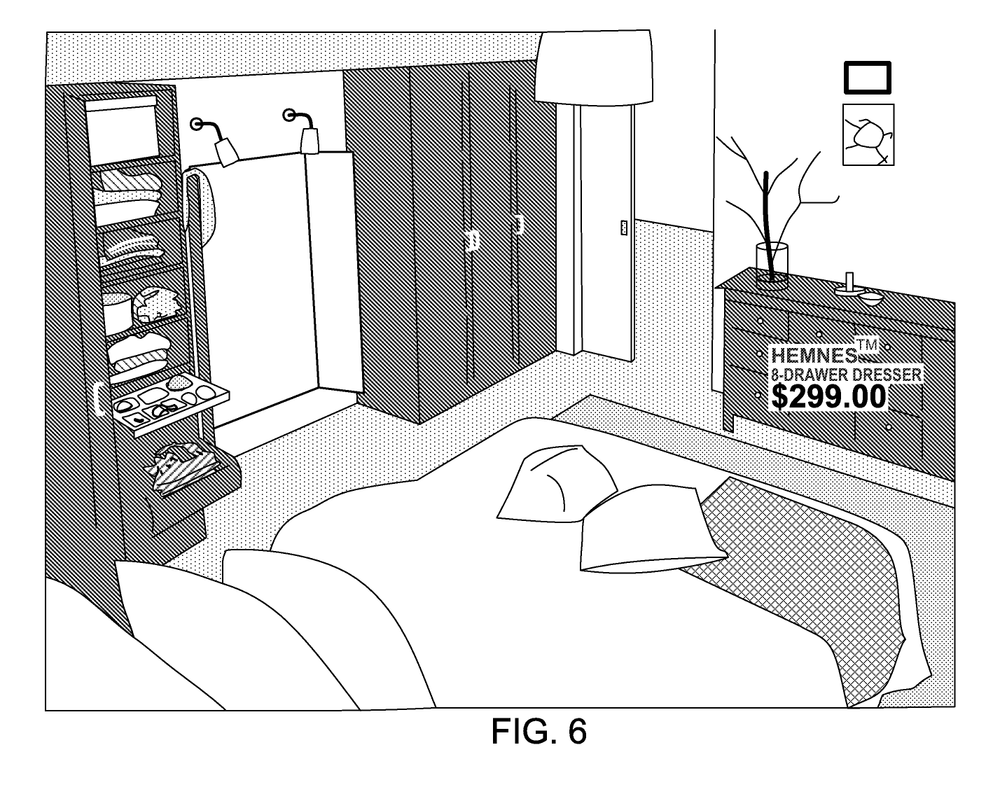

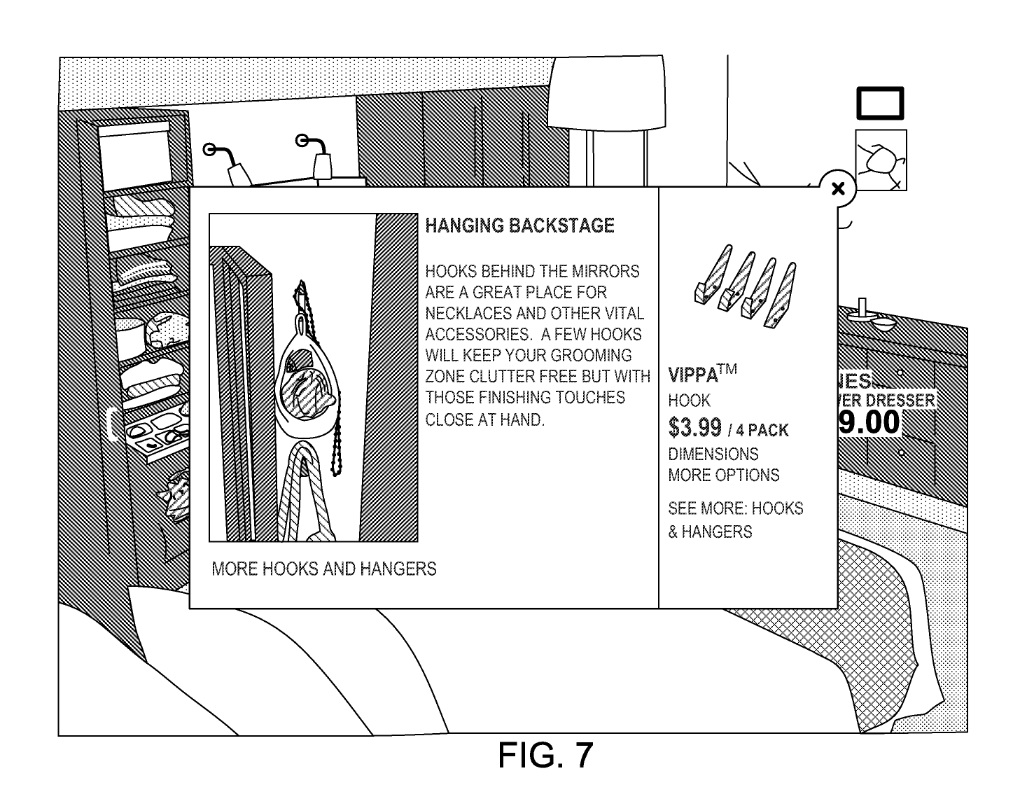

An ecommerce marketplace user on a social networking platform, might like to see admired brands and “looks” that she might find on an ecommerce marketplace because she is not familiar with the inventory. This is seen in FIG. 6. A clickable image map featuring latest a “look book” of ecommerce marketplace inventory could be provided to the user. There may be included high-end brands, or seasonally relevant items. Most items featured within the photo of FIG. 6 are for sale on the ecommerce site. The user may click on the item and get an in-context popup as shown in FIG. 7. The user may bid/BIN an item. The user may push a look book page to a social networking platform. This could be for the purpose of obtaining an opinion as discussed above. Alternatively, this function could be used to share the item with the user's Facebook or social networking platform social graph. Two examples of the reason for doing this might be (1) to solicit feedback about the item pushed to the social graph, or (2) to recommend the item to friends.

eCommerce Marketplace Coupon Pyramid

As a frequent user of an ecommerce marketplace shopper who also uses a social networking platform, a user might like away to share great discounts with her friends so that they may all save money. As an ecommerce marketplace marketer, the user might like to run viral percent off-based promotions, but have a way to cap them at N coupons so the promotion doesn't run out of control. This could be implemented to work as a pyramid scheme. For example, a first degree buyer is awarded a 30% off coupon and ten 25% referral coupons. Ten referrals may send five 20% off referral coupons and five referrals may send a 15% off referral coupon. Those people who were many degrees of separation from the host may be allowed to opt-in for an alert on the next promotion, to be prepared for the next time.

### My Wardrobe/Closet

As a fashionista, a user may like a way to share clothes with her friends as a form of self expression. The user may post items they own to her Facebook wall. Viewers may browse user's closet and recommend matching items from an ecommerce marketplace inventory. The user may in turn view those items recommended by friends. Viewers may do a “likeness” search off any item in their friend's closet. The item inventory would be stored in the network-based marketplace's, here eBay's, data model, but the actual closet could be rendered either on the marketplace such as eBay, for example as a page within eBay.com, or on Facebook as a Facebook App.

### Description of Flow Charts

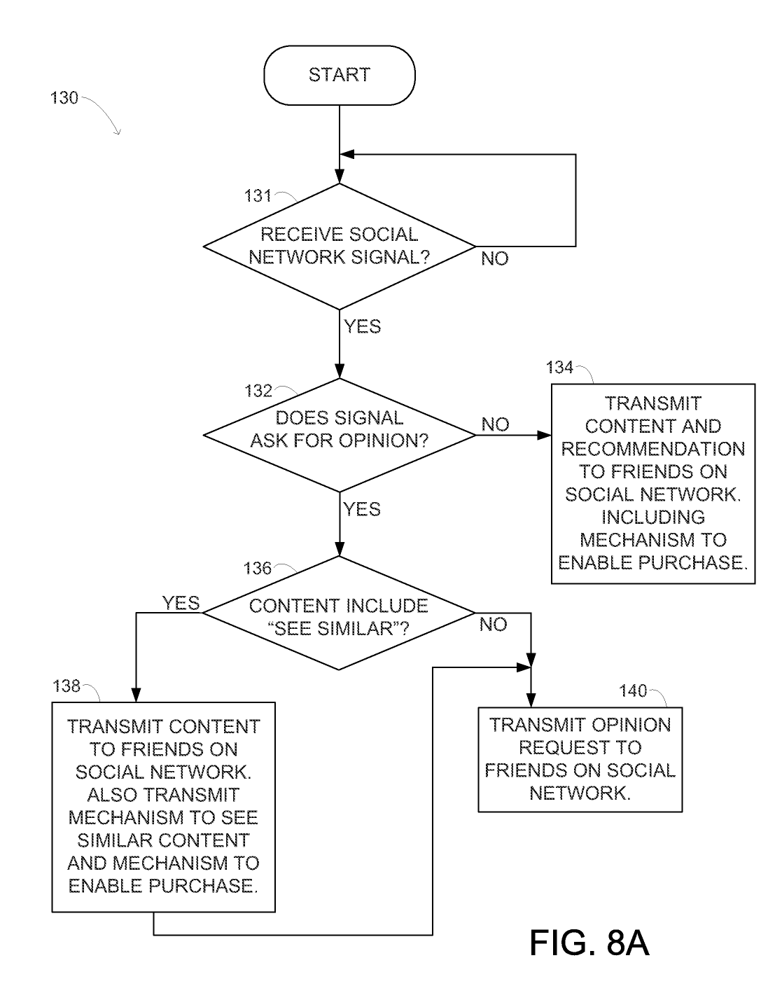

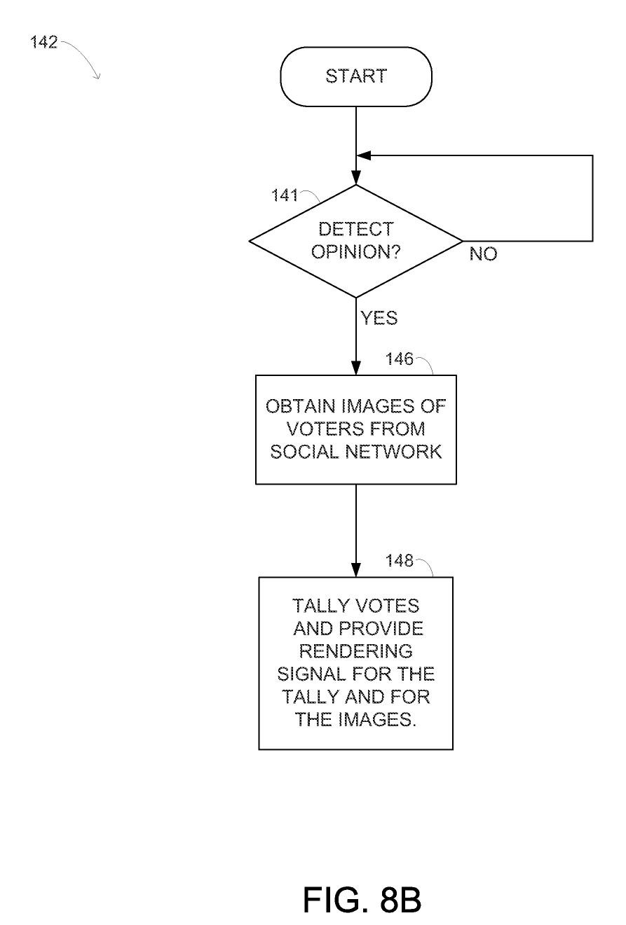

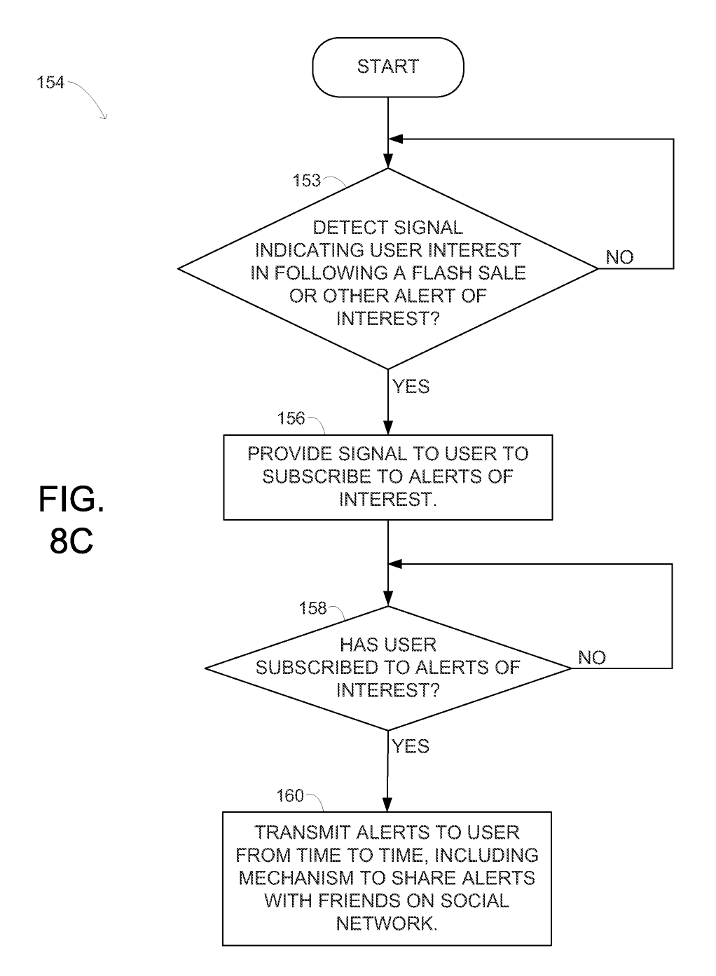

FIGS. 8A, 8B, and 8C are flowcharts respectively illustrating method 130 for providing signals enabling the SHARE MY TRANSACTION and/or GET AN OPINION embodiment above, method 142 for receiving an opinion back from a friend after a request for opinion, and method 154 in which a user expresses an interest in following sales of interest. The methods may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 3A.

In FIG. 8A illustrates a method 130 of a user of an eCommerce marketplace asking friends on a social network, or on another social platform integrated into an eCommerce marketplace, for an opinion, which may be a vote. At decision block 131, an ecommerce marketplace receives a signal from a user that indicates that the user wants to send images of commercial items to the user's own user space on a social network, or the user space of a friend on a social network. It could also be sent to the user's, or a friend's social platform integrated in the ecommerce marketplace. This space could be that known as the “wall” or the “social graph” on a social network. This could be for sharing a transaction or obtaining an opinion on a commercial item. When a signal is received indicating the user would like to push a commercial item to a user on a social network, the decision block 131 takes the Yes path to decision bock 132. If the signal does not include a request for an opinion from the friend, then decision block 132 takes the No path, to block 134, to transmit content and recommendations to friends on the social network. This could include a mechanism, discussed above, to enable the friend to purchase the content on an ecommerce marketplace. On the other hand, if the signal at decision block 132 does ask for an opinion, the system can check, as at decision point 136, whether the user wants the friend to receive “See Similar Items” functionality. If yes, the mechanism to see similar content is sent to the friend, as at block 138. Alternatively, the “See Similar” function could be automatically sent with every commercial item pushed to a friend. The request for an opinion can then also be sent to the friend, as at block 140. If on the other hand, no “See Similar” mechanism is to be forwarded to the friend, the No path is taken at decision block 136 and the opinion request is sent as at block 140.

FIG. 8B illustrates one embodiment implementing or using a social influence function when receiving an opinion back from the request of FIG. 8A. Decision point 141 seeks opinions back from friends or other users, in response to commercial items pushed by an ecommerce marketplace user. When an opinion is detected at decision block 141, the Yes path is taken from decision block 141, and at block 146 an image, such as a “thumbnail,” of the person casting the vote is provided to the user who pushed the commercial item to the voter. The image could, in one embodiment, be automatically collected from the voter's social network or social platform page. Alternatively, merely the name of the person casting the vote could be collected. The reason for providing the image (or the name) is so the user can know who cast the vote, the concept being that the vote of a given person may mean more than the vote of a different person or other persons. The votes can be tallied as at block 148 and a rendering signal is provided to render the result and the photos or other identification of the voters to the user as discussed above with respect to FIG. 4A and FIG. 4B. The image of the person rendering the opinion is provided at block 148 for the same reason as explained with respect to block 146. The opinions can be tallied, including such functions as providing a graphical representation of opinions, as at Results 83 of FIG. 4A.

Turning to FIG. 8C, method 154 indicates an implementation of sending alerts to users, including friends on a social network. As is seen at decision block 153, the system detects a signal indicating a user is interested in following a flash sale. This can be any other type of transactional event of interest, some of which were discussed previously. If such a signal is detected, the Yes path is taken from decision block 154 and, as at block 156, a signal is provided to the user to enable the user to subscribe to alerts of interest. Decision block 158 checks to determine whether the user has subscribed to follow any events of interest. If the user has so subscribed, then the Yes path is take from decision block 158 and, at block 160, the system sends alerts to the user from time to time, as they occur. An alert can include a mechanism to allow the user to share alerts with friends on the social network. An additional mechanism to allow the friend to access the ecommerce marketplace to purchase commercial items for sale can also be included at block 160. Mechanisms discussed herein may simply be a link to the appropriate ecommerce marketplace function page.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor') that is temporarily configured by software to perform certain operations. It may be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet') and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

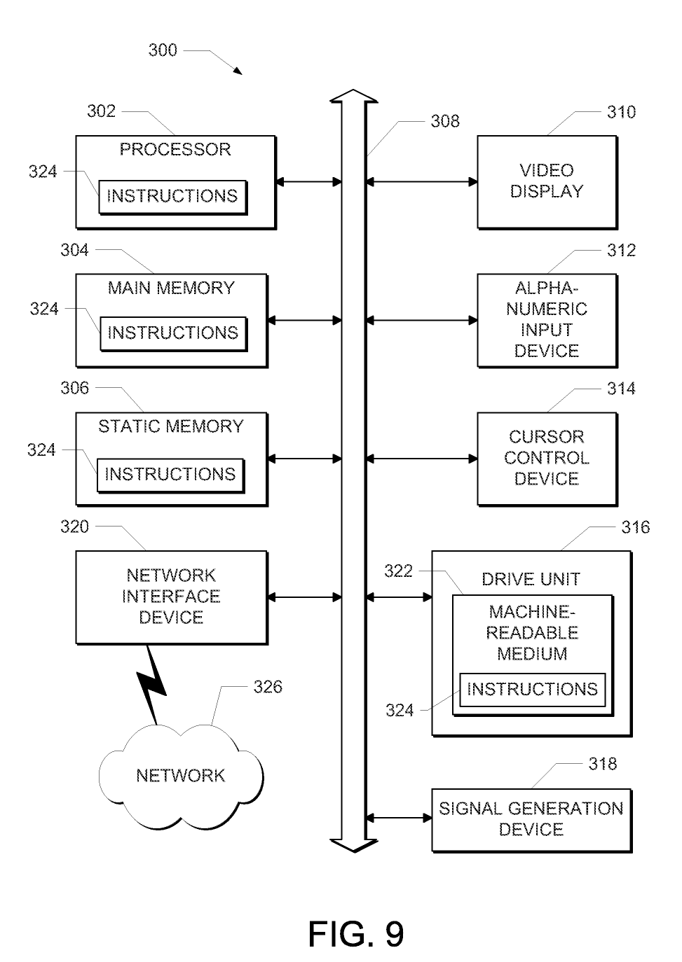

FIG. 9 is a block diagram of machine in the example form of a computer system 300 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker and a network interface device 320.

### Machine-Readable Medium

The disk drive unit 316 includes a machine-readable medium 322 on which is stored one or more sets of data structures and instructions 324 (e.g., software) embodying or utilized by any one or more of the methodologies or functions described herein. The instructions 324 may also reside, completely or at least partially, within the main memory 304, static memory 306, and/or within the processor 302 during execution thereof by the computer system 300, the main memory 304 and the processor 302 also constituting machine-readable media.

While the machine-readable medium 322 is shown in an example embodiment to be a single medium, the term “machine-readable medium” may include a single medium or multiple media (e.g., a centralized or distributed database, and/or associated caches and servers) that store the one or more instructions 324 or data structures. The term “machine-readable medium” shall also be taken to include any tangible medium that is capable of storing, encoding or carrying instructions for execution by the machine and that cause the machine to perform any one or more of the methodologies of the described implementations, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 324 may further be transmitted or received over a communications network 326 using a transmission medium. The instructions 324 may be transmitted using the network interface device 320 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Win and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
using a computer processor, receiving from a user of an ecommerce marketplace one or more first signals identifying content to be transmitted to a social network server for storing at a message space of a user of the social network server;
analyzing the one or more first signals; and
responsive to the analysis of the one or more first signals, providing to the social network server one or more second signals requesting the user of a social network to provide an opinion about the content.

2. The method of claim 1 where the content identified in the one or more first signals includes information describing/identifying a commercial item.

3. The method of claim 2 wherein the content comprises an image of the commercial item and the one or more first signals includes a signal for enabling the user of the social network to see images of additional items like the commercial item.

4. The method of claim 2 wherein the commercial item is one of the group consisting of clothing, shoes and accessories.

5. The method of claim 2 wherein the one or more second signals includes a signal for enabling the user of the social network to purchase one or more commercial items.

6. The method of claim 2, the method further comprising:
receiving at least one of an opinion concerning the commercial item from, and an image of a user of the social network; and
providing at least one of a signal for rendering the opinion and a signal for rendering the image of the user who provided the opinion.

7. The method of claim 6 wherein the signal for rendering the opinion is provided by the user of the social network selecting a graphical user interface element to generate and communicate that the user of the social network has a favorable opinion concerning the commercial item.

8. The method of claim 6 wherein the opinion is one of a group of opinions consisting of: a two-choice poll and a multiple choice poll.

9. The method of claim 8, the method further including:
providing a signal used for tallying a plurality of votes; and
responsive to a tally of the plurality of votes, providing a signal to allow the tally of the votes to be rendered for viewing by one of a group consisting of the user of the ecommerce marketplace and a user of the social network who provided a vote.

10. The method of claim 8 wherein the rendering is in at least one of a bar chart, a pie-shaped percentage graph, or a bell-shaped curve format.

11. The method of claim 1 wherein the user of the ecommerce marketplace is a member of the social network and subscribes to alerts of special interest, the alerts being streamed to a social network web page of the user of the ecommerce marketplace.

12. The method of claim 11, wherein the alerts streamed to the wall include a mechanism to allow users of the social network viewing the wall to receive information about the alerts.

13. The method of claim 1, wherein the content comprises an image resembling a paper doll, the paper doll having a capability of having parts electronically superimposed with images of articles of clothing, the method further comprising:
receiving from a client machine a second signal indicating an article of clothing desired to be electronically superimposed on the paper doll;
responsive to the second signal, querying a database for images representing the article of clothing; and
providing to the client machine a first response signal representing the desired images for electronically superimposing on the paper doll.

14. The method of claim 13 further comprising receiving from the client machine a third signal requesting articles of clothing similar to the indicated article of clothing.

15. The method of claim 14 further comprising querying a database for images of articles of clothing similar to the indicated article of clothing and providing to the client machine a second response signal representing images of the articles of clothing that are similar to the indicated article of clothing, for electronically superimposing on the paper doll.

16. A non-transitory computer-readable storage medium having embedded therein a set of instructions which, when executed by one or more processors of a computer, causes the computer to execute the following operations:
receiving one or more first signals identifying content to be transmitted to a social network server for storing at a message space of a user of a social network;
analyzing the one or more first signals; and
responsive to the analysis of the one or more first signals, providing to the social network server one or more second signals identifying the content and requesting the user of the social network to provide an opinion about the content.

17. The storage medium of claim 16 wherein the content identified in the one or more first signals is a commercial item and the one or more first signals comprises information that includes a picture of at least part of a commercial item.

18. The storage medium of claim 17 wherein the commercial item is one of a group consisting, of clothing, shoes and accessories.

19. The storage medium of claim 17, the operations further including enabling the user of the social network to view items similar to the commercial item.

20. The storage medium of claim 19, the operations further including enabling the user of the social network to purchase one or more of the commercial items.

21. The storage medium of claim 16 wherein the opinion is that the user of the social network likes the commercial item.

22. The storage medium of claim 17, the operations further including enabling users of the social network to cast a vote for the commercial item.

23. The storage medium of claim 16 wherein the opinion is one of a group of opinions consisting of: a two-choice poll and a multiple-choice poll.

24. The storage medium of claim 22, the operations further including enabling a tallying of a plurality of votes; and responsive to the tallying of the plurality of votes, enabling the tally of the votes to be rendered for viewing by a user.

25. The storage medium of claim 24 wherein the rendering is viewable by the user of the social network.

26. The storage medium of claim 24 wherein the rendering is in at least one of a bar chart, a pie-shaped, or a bell-shaped curve format.

27. The storage medium of claim 16, wherein the content comprises an image resembling a paper doll, the paper doll having a capability of having parts electronically superimposed with images of articles of clothing, the operations further comprising:
receiving from a client machine a second signal indicating an article of clothing desired to be electronically superimposed on the paper doll;
responsive to the second signal, querying a database for images representing the article of clothing; and
providing to the client machine a first response signal representing the desired images for electronically superimposing on the paper doll.

28. The storage medium of claim 27, the operations further comprising receiving from the client machine a third signal requesting articles of clothing similar to the indicated article of clothing.

29. The storage medium of claim 28, the operations further including querying a database for images of articles of clothing similar to the indicated article of clothing and providing to the client machine a second response signal representing images of the articles of clothing that are similar to the indicated article of clothing, for electronically superimposing on the paper doll.

30. A system comprising:
one or more computer processors and storage configured to store and execute:
a receiver module for receiving one or more first signals identifying content to be transmitted to a social network server for storing at a message space of a user of a social network, and a request for the user of the social network to render an opinion regarding the content; and
an analysis module including a detector module responsive to the receiver module for detecting the content, an identity of the social network, and an identity of the user of the social network, the analysis module further including a rendering signal module, and a transmission module,
the rendering signal module responsive to the detector module for providing a rendering signal for rendering the content to the user of the social network; and
the transmission module responsive to the detector module for providing to the social network server the rendering signal and a second signal requesting the user of the social network to provide an opinion about the content.

31. The method of claim further including receiving opinions from a plurality of users and the identity of the users rendering the opinions, and providing a signal for displaying the results of the opinion and the identities of the users rendering the opinion.

32. The method of claim 31 wherein the displaying includes displaying the identities of the users rendering the opinions adjacent the results of the opinions.

33. The method of claim 32 wherein the identities of the users rendering the opinions can be highlighted, the method further including receiving an order to purchase an item represented by the content, the order based on the identity of one or more of the users rendering the opinion.

34. The method of claim 33 wherein the highlighting is by fly-out navigation.

35. The storage medium of claim 16, the operations further including receiving opinions from a plurality of users and the identities of the users rendering the opinions, and providing a signal for displaying the results of the opinions and the identities of the users rendering the opinions.

36. The storage medium of claim 35 wherein the displaying includes displaying the identities of the users rendering the opinions adjacent the results of the opinions.

37. The storage medium of claim 36 wherein the identities of the users rendering the opinions can be highlighted, the operations further including receiving an order to purchase an item represented by the content, the order based on the identity of one or more of the users rendering the opinions.

38. The storage medium of claim 36 wherein the highlighting is by fly-out navigation.

39. The method of claim 13 wherein the paper doll is personalized by one of the group consisting of using a photograph of the face of a user of an electronic system for the head of the paper doll and using a photograph of the user of an electronic system as the paper doll.

40. The storage medium of claim 27 the paper doll is personalized by one of the group consisting of using a photograph of the face of a user of an electronic system for the head of the paper doll and using a photograph of the user of an electronic system as the paper doll.

41. A computer-implemented method comprising:
using a computer processor, receiving from a user of an ecommerce marketplace one or more first signals identifying content to be transmitted storage space of one or more second users on a networked server;
analyzing the one or more first signals; and
responsive to the analysis of the one or more first signals, providing one or more second signals requesting the one or more second users to provide an opinion about the content, the request being sent by email.

42. The method of claim 41 wherein the opinion is one of a group of opinions consisting of: a two-choice poll and a multiple choice poll.

43. The method of claim 41 wherein the one or more second users are a plurality of second users, the method further including receiving opinions from a set of the plurality of second users and the identity of the set of the plurality of second users rendering the opinions, and providing a signal for displaying the results of the opinion and the identities of the set of the plurality of second users rendering the opinion.

44. The method of claim 43 wherein the displaying includes displaying the identities of the set of the plurality of second users rendering the opinions adjacent the results of the opinions.

45. The method of claim 44 wherein the identities of the set of the plurality of second users rendering the opinions can be highlighted, the method further including receiving an order from the user of the ecommerce marketplace to purchase an item represented by the content, the order based on the identity of one or more of the set of the plurality of second users rendering the opinion.

46. The method of claim 45 wherein the highlighting is by fly-out navigation.
